(19) United States
(12) Patent Application Publication
(10) Pub. No.: US 2024/0340799 A1
(43) Pub. Date: Oct. 10, 2024

(54) METHOD FOR INFORMATION PROCESSING, USER EQUIPMENT, AND NETWORK DEVICE

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN)

(21) Appl. No.: 18/745,981

(22) Filed: Jun. 17, 2024

Related U.S. Application Data
(63) Continuation of application No. PCT/CN2021/140460, filed on Dec. 22, 2021.

(51) Int. Cl. H04W 52/02; H04W 28/02; H04W 72/1268; H04W 74/0833

(52) U.S. Cl. CPC H04W 52/0235; H04W 28/0278; H04W 72/1268; H04W 74/0833

(57) ABSTRACT

This disclosure relates to a method for information processing, a user equipment (UE), and a network device. The method includes the following. After receiving target indication information from a network side, a user equipment (UE) determines, according to a transmitting/receiving state of the UE, whether to respond to the target indication information. The target indication information indicates the UE to enter a low-power receiving state.

### CROSS REFERENCE TO RELATED APPLICATION(S)

This application is a continuation of International Application No. PCT/CN2021/140460, filed Dec. 22, 2021, the entire disclosure of which is incorporated herein by reference.

### TECHNICAL FIELD

This disclosure relates to the field of wireless communication technology, and in particular, to a method for information processing, a user equipment (UE), and a network device.

### BACKGROUND

Currently, in order to reduce power consumption of a user equipment (UE), a low-power receiving technology is introduced in a wireless communication system. In the low-power receiving technology, the UE is provided with an ultra-low power wake-up receiver and a main radio. When the UE is in a normal receiving state, the main radio operates normally. When the UE is in a low-power receiving state, the main radio enters an off or deep sleep state, and the ultra-low power wake-up receiver operates normally. In general, the UE in the normal receiving state can enter the low-power receiving state after receiving an indication from a network side. The UE in the low-power receiving state can enter the normal receiving state after receiving a wake-up signal from the network side.

However, at present, the switch of the UE from the normal receiving state to the low-power receiving state has a problem of low flexibility.

### SUMMARY

In a first aspect, a method for information processing is provided in embodiments of the disclosure. The method includes the following. After receiving target indication information from a network side, a user equipment (UE) determines, according to a transmitting/receiving state of the UE, whether to respond to the target indication information. The target indication information indicates the UE to enter a low-power receiving state.

In a second aspect, a user equipment (UE) is provided in embodiments of the disclosure. The UE includes: a transceiver, a memory configured to store computer programs, and a processor configured to execute the computer programs stored in the memory to: determine, according to a transmitting/receiving state of the UE, whether to respond to target indication information, after receiving the target indication information from a network side. The target indication information indicates the UE to enter a low-power receiving state.

In a third aspect, a network device is provided in embodiments of the disclosure. The network device includes: a transceiver, a memory configured to store computer programs, and a processor configured to execute the computer programs stored in the memory to cause the transceiver to: transmit target indication information to a user equipment (UE). The target indication information is used by the UE for determining, according to a transmitting/receiving state of the UE, whether to respond to the target indication information. The target indication information indicates the UE to enter a low-power receiving state.

### BRIEF DESCRIPTION OF THE DRAWINGS

FIG. 1 is a schematic diagram illustrating operation of a low-power receiving technology according to an embodiment.

FIG. 2 is a schematic diagram illustrating operation of a low-power receiving technology according to an embodiment.

FIG. 3 is a flowchart of a method for information processing according to an embodiment.

FIG. 4 is a schematic diagram of a method for information processing according to an embodiment.

FIG. 5 is a schematic diagram of a method for information processing according to an embodiment.

FIG. 6 is a schematic diagram of a method for information processing according to an embodiment.

FIG. 7 is a block diagram of an apparatus for information processing according to an embodiment.

FIG. 8 is a block diagram of a communication device according to an embodiment.

FIG. 9 is a block diagram of a chip according to an embodiment.

### DETAILED DESCRIPTION

In order to make the objectives, technical solutions, and advantages of the disclosure clearer, the disclosure will be further described in detail below with reference to the accompanying drawings and embodiments. It may be understood that, the embodiments described herein are merely intended for explaining the disclosure rather than limiting the disclosure.

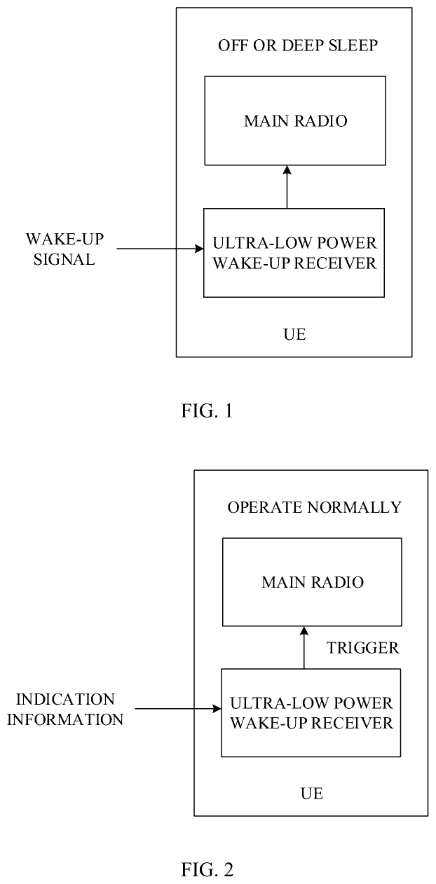

Currently, a low-power receiving technology is introduced in a wireless communication system. Reference is made to FIG. 1 and FIG. 2, where FIG. 1 and FIG. 2 are schematic diagrams illustrating operation of a low-power receiving technology.

As illustrated in FIG. 1 and FIG. 2, a user equipment (UE) may be provided with an ultra-low power wake-up receiver and a main radio. The ultra-low power wake-up receiver has low power consumption, and the main radio has high power consumption.

FIG. 1 is a schematic diagram illustrating the UE in a low-power receiving state. As illustrated in FIG. 1, in the low-power receiving state, the main radio enters an off or deep sleep state, and the ultra-low power wake-up receiver operates normally. After receiving a wake-up signal from a network side, the ultra-low power wake-up receiver can wake up the main radio, so that the UE can enter a normal receiving state.

FIG. 2 is a schematic diagram illustrating the UE in a normal receiving state. As illustrated in FIG. 2, in the normal receiving state, both the main radio and the ultra-low power wake-up receiver operate normally. After receiving indication information from a network side, the ultra-low power wake-up receiver can trigger the main radio to enter an off or deep sleep state, so that the UE can enter a low-power receiving state.

Currently, as long as the UE in the normal receiving state receives the indication information from the network side, the UE enters the low-power receiving state according to the indication from the network side. However, such a manner has low flexibility.

In view of this, a method and apparatus for information processing, a device, and a storage medium are provided in embodiments of the disclosure. In this method for information processing, after receiving target indication information from the network side, the UE can determine, according to a transmitting/receiving state of the UE, whether to respond to the target indication information. The target indication information indicates the UE to enter the low-power receiving state. In this way, the UE can flexibly determine, according to the transmitting/receiving state of the UE, whether to enter the low-power receiving state in response to the indication from the network side. Therefore, the flexibility of the switch of the UE from the normal receiving state to the low-power receiving state can be improved.

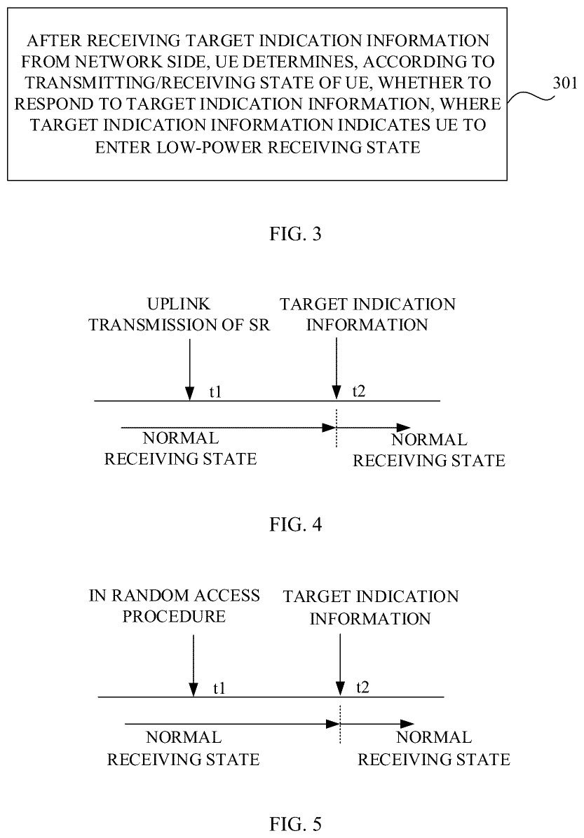

Reference is made to FIG. 3, where FIG. 3 illustrates a method for information processing according to embodiments of the disclosure. The method for information processing can be applied to a UE. As illustrated in FIG. 3, the method for information processing includes the following.

At 301, after receiving target indication information from a network side, a UE determines, according to a transmitting/receiving state of the UE, whether to respond to the target indication information. The target indication information indicates the UE to enter a low-power receiving state.

Currently, when the UE is in a normal receiving state, the network side can predict requirements of the UE for data transmission in a period of time in the future. If the network side predicts that the UE has no requirement for data transmission in a period of time in the future, the network side can deliver the target indication information to the UE. As long as the UE receives the target indication information, the UE enters the low-power receiving state according to the indication from the network side.

However, in actual application, the network side may not accurately predict requirements of the UE for data transmission in a period of time in the future. In a case where the UE has requirements for transmission, if the UE enters the low-power receiving state according to the indication from the network side, normal operation of the UE will be affected.

For example, in some scenarios, the UE may trigger an uplink transmission and thus expect a further response from the network side. From the perspective of the network side, only after receiving data of the uplink transmission triggered by the UE, the network side can know that the UE has requirements for data transmission. Before receiving data of the uplink transmission triggered by the UE, the network side cannot know that the UE has requirements for data transmission. In this case, the network side may mispredict that the UE has no requirement for data transmission in a period of time in the future, thereby indicating the UE to enter the low-power receiving state. In this case, if the UE enters the low-power receiving state according to the indication from the network side, normal operation of the UE will be affected.

In view of this, in embodiments of the disclosure, after receiving the target indication information from the network side, the UE can determine, according to the transmitting/receiving state of the UE, whether to respond to the target indication information. In this way, the UE can be prevented from blindly entering the low-power receiving state according to the indication from the network side, thereby ensuring normal operation of the UE.

In an optional embodiment of the disclosure, if the UE has triggered an uplink transmission and there is no response from the network side to the triggered uplink transmission, it means that the UE has requirements for data transmission in a period of time in the future. In this case, the UE may ignore the target indication information, do not respond to the target indication information, and remain in the normal receiving state.

In addition, if the UE has not triggered an uplink transmission, it means that the prediction of requirements of the UE for data transmission in a period of time in the future by the network side may be accurate. In this case, the UE can respond to the target indication information, so as to enter a low-power receiving state.

If the UE has triggered an uplink transmission and there is a response from the network side to the triggered uplink transmission, it means that the UE currently has no requirement for monitoring a downlink channel and receiving downlink data. In this case, the prediction of requirements of the UE for data transmission in a period of time in the future by the network side may also be accurate. In this case, the UE can respond to the target indication information, so as to enter the low-power receiving state.

Three typical cases in which “the UE has triggered an uplink transmission and there is no response from the network side to the triggered uplink transmission” are provided in embodiments of the disclosure. It may be noted that, these three cases are merely exemplary. In actual application, all UE transmitting/receiving cases satisfying the condition that “the UE has triggered an uplink transmission and there is no response from the network side to the triggered uplink transmission” may be included in the scope of protection of the disclosure.

In a first case, the UE has triggered an uplink transmission of a scheduling request (SR) and the triggered uplink transmission of the SR is in a pending state.

It may be noted that, the UE involved in the first case is a UE in a radio resource control (RRC) connected state.

The SR is short for the scheduling request, which represents an uplink scheduling request. Generally, when the UE has requirements for uplink data transmission and has no physical uplink shared channel (PUSCH) communication resource available for uplink transmission, the UE can transmit the SR to the network side, so as to indicate the network side to allocate an uplink resource to the UE.

In general, since the network side cannot determine when the UE has requirements for uplink data transmission, the network side cannot determine when the UE triggers the uplink transmission of the SR. Therefore, in a case where the UE has triggered the uplink transmission of the SR but the network side has not received the SR from the UE, the network side may mispredict that the UE has no requirement for data transmission in a period of time in the future, and indicate, according to the prediction, the UE to enter the low-power receiving state.

In consideration of the above case, when the UE has triggered the uplink transmission of the SR and the triggered uplink transmission of the SR is in the pending state (that is, there is no response from the network side to the triggered uplink transmission of the SR), the UE can ignore the target indication information delivered by the network side, thereby ensuring that the UE can be maintained in the normal receiving state.

The pending state of the uplink transmission of the SR includes: a state in which the SR is not transmitted to the network side on an uplink communication resource; and/or a state in which the SR is transmitted to the network side on an uplink communication resource and no response information for the SR is received from the network side.

Generally speaking, the UE can transmit the SR on an uplink communication resource in a physical uplink control channel (PUCCH). In actual application, a case where the UE has triggered the uplink transmission of the SR but the UE still needs to wait for a PUCCH uplink communication resource for transmission of the SR may occur. In this case, the uplink transmission of the SR is in the pending state, i.e., the state in which the SR is not transmitted to the network side on the uplink communication resource. In addition, in actual application, in a case where the SR is transmitted by the UE on the PUCCH uplink communication resource, the network side usually can receive and respond to the SR only after a period of time. Within this period of time, the uplink transmission of the SR is in the pending state, i.e., the state in which the SR is transmitted to the network side on the uplink communication resource and no response information for the SR is received from the network side.

In order to facilitate the understanding of the technical solutions involved in the first case, reference is made to FIG. 4. As illustrated in FIG. 4, the UE triggers the uplink transmission of the SR at a time t1, and receives the target indication information from the network side at a time t2. Since the uplink transmission of the SR is in the pending state at the time t2, the UE ignores the target indication information, does not respond to the target indication information, and continues to remain in the normal receiving state.

In a second case, the UE is in a random access procedure.

It may be noted that, the random access procedure involved in the second case may be a contention based random access (CBRA) procedure or a contention free random access (CFRA) procedure. The UE involved in the second case may be a UE in an RRC connected state, a UE in an RRC idle state, or a UE in an RRC inactive state.

In some scenarios, the random access procedure is triggered by the UE. Therefore, before receiving a random access message from the UE, the network side may not know that the UE has triggered the random access procedure. In this case, the network side may mispredict that the UE has no requirement for data transmission in a period of time in the future, and indicate, according to the prediction, the UE to enter the low-power receiving state.

In consideration of the above case, when the UE is in the random access procedure, the UE can ignore the target indication information delivered by the network side, thereby ensuring that the UE can be maintained in the normal receiving state.

The UE being in the random access procedure may include the following.

1. The UE has triggered a random access and has not transmitted random access message 1 or random access message A to the network side on an uplink communication resource.

2. The UE has triggered a random access and has not received random access message 2 or random access message B from the network side.

Generally speaking, the random access may include a four-step random access and a two-step random access. During the four-step random access, the UE transmits the random access message 1 to the network side, the network side transmits the random access message 2 to the UE based on the random access message 1, the UE transmits random access message 3 to the network side based on the random access message 2, and the network side transmits random access message 4 to the UE based on the random access message 3. In this way, the random access procedure is completed. During the two-step random access, the UE transmits the random access message A to the network side, and the network side transmits the random access message B to the UE based on the random access message A. In this way, the random access procedure is completed.

If the UE has triggered the random access but has not transmitted the random access message 1 or the random access message A to the network side on the uplink communication resource (for example, the UE is waiting for an uplink communication resource available for transmitting the random access message 1 or the random access message A), the network side may not know that the UE has triggered the random access. In this case, the network side may mispredict that the UE has no requirement for data transmission in a period of time in the future, and indicate, according to the prediction, the UE to enter the low-power receiving state. In consideration of this, the UE may ignore the target indication information delivered by the network side, thereby ensuring that the UE can be maintained in the normal receiving state.

In addition, if the UE has triggered the random access but has not received the random access message 2 or the random access message B from the network side, the network side may have not received the random access message 1 or the random access message A transmitted by the UE. In this case, the network side may not know that the UE has triggered the random access. As a result, the network side may mispredict that the UE has no requirement for data transmission in a period of time in the future, and indicate, according to the prediction, the UE to enter the low-power receiving state. In consideration of this, the UE may ignore the target indication information delivered by the network side, thereby ensuring that the UE can be maintained in the normal receiving state.

In order to facilitate the understanding of the technical solutions involved in the second case, reference is made to FIG. 5. As illustrated in FIG. 5, the UE is in the random access procedure from a time t1, and receives the target indication information from the network side at a time t2. Since the UE is still in the random access procedure at the time t2, the UE ignores the target indication information, does not respond to the target indication information, and continues to remain in the normal receiving state.

In a third case, the UE has triggered an uplink transmission of a buffer status report (BSR) and the BSR is in an un-cancelled state.

It may be noted that, the UE involved in the third case is a UE in an RRC connected state.

The BSR is short for the buffer status report, which represents a report of buffer status. Generally, when the UE has requirements for uplink data transmission, the UE can transmit the BSR to the network side, so as to inform the network side of a data volume of uplink data to be transmitted by the UE. In this way, the network side can allocate to the UE an uplink resource necessary for transmission of the uplink data based on the data volume reported by the UE.

In general, the network side cannot determine when the UE triggers the uplink transmission of the BSR. Therefore, in a case where the UE has triggered the uplink transmission of the BSR but the network side has not received the BSR from the UE, the network side may mispredict that the UE has no requirement for data transmission in a period of time in the future, and indicate, according to the prediction, the UE to enter the low-power receiving state.

In consideration of the above case, when the UE has triggered the uplink transmission of the BSR and the BSR is in the un-cancelled state (that is, there is no response from the network side to the BSR), the UE can ignore the target indication information delivered by the network side, thereby ensuring that the UE can be maintained in the normal receiving state.

The un-cancelled state of the BSR includes: a state in which the BSR is not transmitted to the network side on an uplink communication resource; and/or a state in which the BSR is transmitted to the network side on an uplink communication resource and no response information for the BSR is received from the network side.

Generally speaking, the UE can transmit the BSR on an uplink communication resource in a PUSCH. In actual application, a case where the UE has triggered the uplink transmission of the BSR but the UE still needs to wait for a PUSCH uplink communication resource for transmission of the BSR may occur. In this case, the BSR is in the un-cancelled state, i.e., the state in which the BSR is not transmitted to the network side on the uplink communication resource. In addition, in actual application, in a case where the BSR is transmitted by the UE on the PUSCH uplink communication resource, the network side usually can receive and respond to the BSR only after a period of time. Within this period of time, the BSR is in the un-cancelled state, i.e., a state in which the SR is transmitted to the network side on the uplink communication resource, the BSR is transmitted to the network side on the uplink communication resource, and no response information for the BSR is received from the network side.

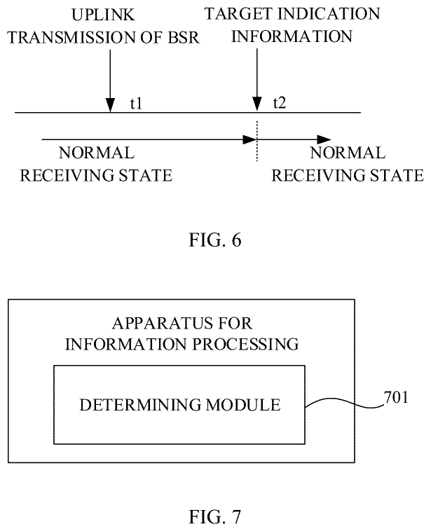

In order to facilitate the understanding of the technical solutions involved in the third case, reference is made to FIG. 6. As illustrated in FIG. 6, the UE triggers the uplink transmission of the BSR at a time t1, and receives the target indication information from the network side at a time t2. Since the BSR is in the un-cancelled state at the time t2, the UE ignores the target indication information, does not respond to the target indication information, and continues to remain in the normal receiving state.

Based on technical solutions provided in embodiments of the disclosure, after receiving the target indication information from the network side, the UE can determine, according to the transmitting/receiving state of the UE, whether to respond to the target indication information. The target indication information indicates the UE to enter the low-power receiving state. In this way, the UE can flexibly determine, according to the transmitting/receiving state of the UE, whether to enter the low-power receiving state in response to an indication from the network side. Therefore, the flexibility of the switch of the UE from the normal receiving state to the low-power receiving state can be improved, and both low power consumption of the UE and quality of service (QOS) of communication services in the UE can be taken into account.

In an embodiment, as illustrated in FIG. 7, an apparatus for information processing is provided. The apparatus for information processing includes a determining module 701.

The determining module 701 is configured to determine, according to a transmitting/receiving state of a UE, whether to respond to target indication information, after receiving the target indication information from a network side. The target indication information indicates the UE to enter a low-power receiving state.

In an optional embodiment of the disclosure, the determining module 701 is specifically configured to ignore the target indication information, when the UE has triggered an uplink transmission and there is no response from the network side to the triggered uplink transmission.

In an optional embodiment of the disclosure, the determining module 701 is specifically configured to ignore the target indication information, when the UE has triggered an uplink transmission of an SR and the triggered uplink transmission of the SR is in a pending state.

In an optional embodiment of the disclosure, the pending state of the uplink transmission of the SR includes: a state in which the SR is not transmitted to the network side on an uplink communication resource; and/or a state in which the SR is transmitted to the network side on an uplink communication resource and no response information for the SR is received from the network side.

In an optional embodiment of the disclosure, the determining module 701 is specifically configured to ignore the target indication information when the UE is in a random access procedure.

In an optional embodiment of the disclosure, the UE being in the random access procedure includes: the UE having triggered a random access and having not transmitted random access message 1 or random access message A to the network side on an uplink communication resource; and/or the UE having triggered a random access and having not received random access message 2 or random access message B from the network side.

In an optional embodiment of the disclosure, the determining module 701 is specifically configured to ignore the target indication information, when the UE has triggered an uplink transmission of a BSR and the BSR is in an un-cancelled state.

In an optional embodiment of the disclosure, the un-cancelled state of the BSR includes: a state in which the BSR is not transmitted to the network side on an uplink communication resource; and/or a state in which the BSR is transmitted to the network side on an uplink communication resource and no response information for the BSR is received from the network side.

For the implementation principles and technical effects, the apparatus for information processing provided in the above embodiments is similar to the above method embodiments, which will not be repeated herein.

For limitation on the apparatus for information processing, reference can be made to the foregoing limitation on the method for information processing, which will not be repeated herein. All or part of the above modules in the apparatus for information processing may be implemented via software, hardware, and any other combination thereof. Each of the above modules may be built in or independent of a processor of a communication device in a form of hardware, or may be stored in a memory of the communication device in a form of software, so as to be invoked by the processor to perform an operation corresponding to each of the above modules.

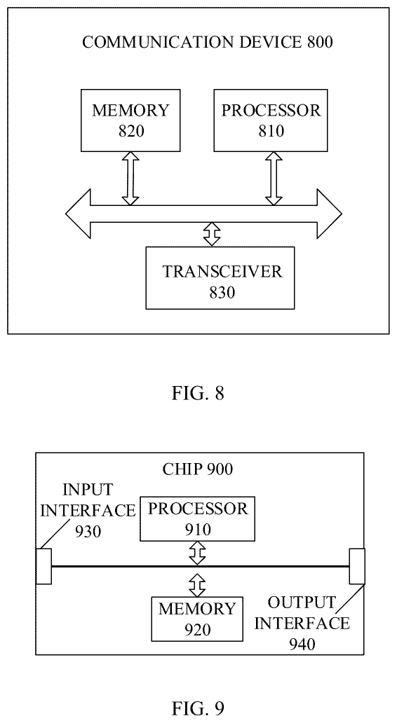

FIG. 8 is a schematic structural diagram of a communication device according to embodiments of the disclosure. The communication device may be a UE. The communication device 800 illustrated in FIG. 8 includes a processor 810. The processor 810 can invoke and execute computer programs stored in a memory, to perform the method in embodiments of the disclosure.

Optionally, as illustrated in FIG. 8, the communication device 800 may further include a memory 820. The processor 810 can invoke and execute the computer programs stored in the memory 820, to perform the method in embodiments of the disclosure.

The memory 820 may be a separate device independent of the processor 810, or may be integrated into the processor 810.

Optionally, as illustrated in FIG. 8, the communication device 800 may further include a transceiver 830. The processor 810 can control the transceiver 830 to communicate with other devices, specifically, to transmit information or data to other devices or to receive information or data transmitted by other devices.

The transceiver 830 may include a transmitter and a receiver. The transceiver 830 may further include an antenna, where one or more antennas can be provided.

Optionally, the communication device 800 can implement the operations performed by the UE in various methods in embodiments of the disclosure, which will not be repeated herein for the sake of simplicity.

FIG. 9 is a schematic structural diagram of a chip according to embodiments of the disclosure. The chip 900 illustrated in FIG. 9 includes a processor 910. The processor 910 can invoke and execute computer programs stored in a memory to perform the method in embodiments of the disclosure.

Optionally, as illustrated in FIG. 9, the chip 900 may further include a memory 920. The processor 910 can invoke and execute the computer programs stored in the memory 920 to perform the method in embodiments of the disclosure.

The memory 920 may be a separate device independent of the processor 910, or may be integrated into the processor 910.

Optionally, the chip 900 may further include an input interface 930. The processor 910 can control the input interface 930 to communicate with other devices or chips, specifically, to obtain information or data transmitted by other devices or chips.

Optionally, the chip 900 may further include an output interface 940. The processor 910 can control the output interface 940 to communicate with other devices or chips, specifically, to output information or data to other devices or chips.

Optionally, the chip 900 is applicable to the communication device 800 in embodiments of the disclosure. The chip 900 can implement the operations performed by the UE in various methods in embodiments of the disclosure, which will not be repeated herein for the sake of simplicity.

It may be understood that, the chip 900 in embodiments of the disclosure may also be referred to as a system-on-chip (SOC).

It may be understood that, the processor in embodiments of the disclosure may be an integrated circuit chip with signal processing capabilities. During implementation, each step of the foregoing method embodiments may be completed by an integrated logic circuit of hardware in the processor or an instruction in the form of software. The processor may be a general-purpose processor, a digital signal processor (DSP), an application specific integrated circuit (ASIC), a field programmable gate array (FPGA), or other programmable logic devices, discrete gates or transistor logic devices, discrete hardware components. The methods, steps, and logic blocks disclosed in embodiments of the disclosure can be implemented or executed. The general-purpose processor may be a microprocessor, or the processor may be any conventional processor or the like. The steps of the method disclosed in embodiments of the disclosure may be directly implemented by a hardware decoding processor, or may be performed by hardware and software modules in the decoding processor. The software module can be located in a storage medium mature in the skill such as a random access memory (RAM), a flash memory, a read only memory (ROM), a programmable ROM (PROM), or an electrically erasable programmable memory, registers, and the like. The storage medium is located in the memory. The processor reads the information in the memory, and completes the steps of the method described above with the hardware thereof.

It may be understood that, the memory in embodiments of the disclosure may be a volatile memory or a non-volatile memory, or may include both the volatile memory and the non-volatile memory. The non-volatile memory may be an ROM, a PROM, an erasable PROM (EPROM), an electrically EPROM (EEPROM), or a flash memory. The volatile memory may be an RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It may be noted that, the memory of the systems and methods described in the disclosure is intended to include, but is not limited to, these and any other suitable types of memory.

It may be understood that, the memory above is intended for illustration rather than limitation. For example, the memory in embodiments of the disclosure may also be an SRAM, a DRAM, an SDRAM, a DDR SDRAM, an ESDRAM, an SLDRAM, a DR RAM, and the like. In other words, the memory in embodiments of the disclosure is intended to include, but is not limited to, these and any other suitable types of memory.

A computer-readable storage medium is further provided in embodiments of the disclosure. The computer-readable storage medium is configured to store computer programs.

Optionally, the computer-readable storage medium may be applied to the UE in embodiments of the disclosure, and the computer programs are operable with the UE to execute corresponding operations implemented by the UE in various methods in embodiments of the disclosure, which will not be repeated herein for the sake of simplicity.

A computer program product is further provided in embodiments of the disclosure. The computer program product includes computer program instructions.

Optionally, the computer program product may be applied to the UE in embodiments of the disclosure, and the computer program instructions are operable with the UE to execute corresponding operations implemented by the UE in various methods in embodiments of the disclosure, which will not be repeated herein for the sake of simplicity.

A computer program is further provided in embodiments of the disclosure.

Optionally, the computer program may be applied to the UE in embodiments of the disclosure. The computer program, when executed by the UE, is operable to implement corresponding operations implemented by the UE in various methods in embodiments of the disclosure, which will not be repeated herein for the sake of simplicity.

Those of ordinary skill in the art will appreciate that units and algorithmic operations of various examples described in connection with embodiments of the disclosure can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods should not be regarded as lying beyond the scope of the disclosure.

It will be evident to those skilled in the art that, for the sake of convenience and simplicity, in terms of the specific working processes of the foregoing systems, apparatuses, and units, reference can be made to the corresponding processes in the foregoing method embodiments, which will not be repeated herein.

It will be appreciated that the systems, apparatuses, and methods disclosed in embodiments of the disclosure may also be implemented in various other manners. For example, the above apparatus embodiments are merely illustrative, e.g., the division of units is only a division of logical functions, and other manners of division may be available in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device, or unit, and may be electrical, mechanical, or otherwise.

Separated units as illustrated may or may not be physically separated. Components displayed as units may or may not be physical units, and may reside at one location or may be distributed to multiple networked units. Some or all of the units may be selectively adopted according to practical needs to achieve desired objectives of the disclosure.

In addition, various functional units described in various embodiments of the disclosure may be integrated into one processing unit or may be present as a number of physically separated units, and two or more units may be integrated into one.

If the functions are implemented as software functional units and sold or used as standalone products, they may be stored in a computer-readable storage medium. Based on such an understanding, the essential technical solution, or the portion that contributes to the prior art, or part of the technical solution of the disclosure may be embodied as software products. The computer software products can be stored in a storage medium and may include multiple instructions that, when executed, can cause a computer device, e.g., a personal computer, a server, a network device, etc., to execute some or all operations of the methods described in various embodiments of the disclosure. The above storage medium may include various kinds of media that can store program codes, such as a universal serial bus (USB) flash disk, a mobile hard drive, an ROM, an RAM, a magnetic disk, or an optical disk.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

The term “and/or” herein only describes an association relationship between associated objects, which means that there can be three relationships. For example, A and/or B can mean A alone, both A and B exist, and B alone. In addition, the character “/” herein generally indicates that the associated objects are in an “or” relationship.

What is claimed is:

1. A method for information processing, comprising:
determining, by a user equipment (UE), according to a transmitting/receiving state of the UE, whether to respond to target indication information, after receiving the target indication information from a network side;
wherein the target indication information indicates the UE to enter a low-power receiving state.

2. The method of claim 1, wherein determining, by the UE, according to the transmitting/receiving state of the UE, whether to respond to the target indication information comprises:
ignoring the target indication information, when the UE has triggered an uplink transmission and there is no response from the network side to the triggered uplink transmission.

3. The method of claim 2, wherein ignoring the target indication information, when the UE has triggered the uplink transmission and there is no response from the network side to the triggered uplink transmission comprises:
ignoring the target indication information, when the UE has triggered an uplink transmission of a scheduling request (SR) and the triggered uplink transmission of the SR is in a pending state.

4. The method of claim 3, wherein the pending state of the uplink transmission of the SR comprises:
a state in which the SR is not transmitted to the network side on an uplink communication resource; and/or
a state in which the SR is transmitted to the network side on an uplink communication resource and no response information for the SR is received from the network side.

5. The method of claim 2, wherein ignoring the target indication information, when the UE has triggered the uplink transmission and there is no response from the network side to the triggered uplink transmission comprises:
ignoring the target indication information when the UE is in a random access procedure.

6. The method of claim 5, wherein the UE being in the random access procedure comprises:
the UE having triggered a random access and having not transmitted random access message 1 or random access message A to the network side on an uplink communication resource; and/or
the UE having triggered a random access and having not received random access message 2 or random access message B from the network side.

7. The method of claim 2, wherein ignoring the target indication information, when the UE has triggered the uplink transmission and there is no response from the network side to the triggered uplink transmission comprises:
ignoring the target indication information, when the UE has triggered an uplink transmission of a buffer status report (BSR) and the BSR is in an un-cancelled state.

8. The method of claim 7, wherein the un-cancelled state of the BSR comprises:
a state in which the BSR is not transmitted to the network side on an uplink communication resource; and/or
a state in which the BSR is transmitted to the network side on an uplink communication resource and no response information for the BSR is received from the network side.

9. A user equipment (UE), comprising:
a transceiver;
a memory configured to store computer programs; and
a processor configured to execute the computer programs stored in the memory to:
determine, according to a transmitting/receiving state of the UE, whether to respond to target indication information, after receiving the target indication information from a network side;
wherein the target indication information indicates the UE to enter a low-power receiving state.

10. The UE of claim 9, wherein the processor configured to determine, according to the transmitting/receiving state of the UE, whether to respond to the target indication information is configured to:
ignore the target indication information, when the UE has triggered an uplink transmission and there is no response from the network side to the triggered uplink transmission.

11. The UE of claim 10, wherein the processor configured to ignore the target indication information, when the UE has triggered the uplink transmission and there is no response from the network side to the triggered uplink transmission is configured to:
ignore the target indication information, when the UE has triggered an uplink transmission of a scheduling request (SR) and the triggered uplink transmission of the SR is in a pending state.

12. The UE of claim 11, wherein the pending state of the uplink transmission of the SR comprises:
a state in which the SR is not transmitted to the network side on an uplink communication resource; and/or
a state in which the SR is transmitted to the network side on an uplink communication resource and no response information for the SR is received from the network side.

13. A network device, comprising:
a transceiver;
a memory configured to store computer programs; and
a processor configured to execute the computer programs stored in the memory to cause the transceiver to:
transmit target indication information to a user equipment (UE), wherein the target indication information is used by the UE for determining, according to a transmitting/receiving state of the UE, whether to respond to the target indication information, and the target indication information indicates the UE to enter a low-power receiving state.

14. The network device of claim 13, wherein determining, according to the transmitting/receiving state of the UE, whether to respond to the target indication information comprises:
ignoring the target indication information, when the UE has triggered an uplink transmission and there is no response from the network device to the triggered uplink transmission.

15. The network device of claim 14, wherein ignoring the target indication information, when the UE has triggered the uplink transmission and there is no response from the network device to the triggered uplink transmission comprises:
ignoring the target indication information, when the UE has triggered an uplink transmission of a scheduling request (SR) and the triggered uplink transmission of the SR is in a pending state.

16. The network device of claim 15, wherein the pending state of the uplink transmission of the SR comprises:
a state in which the SR is not transmitted to the network device on an uplink communication resource; and/or
a state in which the SR is transmitted to the network device on an uplink communication resource and no response information for the SR is received from the network device.

17. The network device of claim 14, wherein ignoring the target indication information, when the UE has triggered the uplink transmission and there is no response from the network device to the triggered uplink transmission comprises:
ignoring the target indication information when the UE is in a random access procedure.

18. The network device of claim 17, wherein the UE being in the random access procedure comprises:
the UE having triggered a random access and having not transmitted random access message 1 or random access message A to the network device on an uplink communication resource; and/or
the UE having triggered a random access and having not received random access message 2 or random access message B from the network device.

19. The network device of claim 14, wherein ignoring the target indication information, when the UE has triggered the uplink transmission and there is no response from the network device to the triggered uplink transmission comprises:
ignoring the target indication information, when the UE has triggered an uplink transmission of a buffer status report (BSR) and the BSR is in an un-cancelled state.

20. The network device of claim 19, wherein the un-cancelled state of the BSR comprises:
a state in which the BSR is not transmitted to the network device on an uplink communication resource; and/or
a state in which the BSR is transmitted to the network device on an uplink communication resource and no response information for the BSR is received from the network device.
